(19) United States
(12) Patent Application Publication
(10) Pub. No.: US 2013/0007290 A1
(43) Pub. Date: Jan. 3, 2013

(54) SYSTEM AND METHOD FOR PROVIDING COMMUNICATION SERVICE

(75) Inventor: Byoung Seok YANG, Seongnam-si (KR)

(73) Assignee: NHN CORPORATION, Seongnam-si (KR)

(21) Appl. No.: 13/533,443

(22) Filed: Jun. 26, 2012

(30) Foreign Application Priority Data
Jun. 28, 2011 (KR) 10-2011-0063065

(51) Int. Cl. G06F 15/16

(52) U.S. Cl. 709/227

(57) ABSTRACT

Provided is a system and method for providing a communication service. According to exemplary embodiments of the present invention, a synchronization session integrated among a plurality of user terminals that use a communication service may be set, and control result data corresponding to terminal control information selected by at least one of user terminals may be provided to user terminals.

### CROSS-REFERENCE TO RELATED APPLICATION

This application claims priority from and the benefit of Korean Patent Application No. 10-2011-0063065, filed on Jun. 28, 2011, which is hereby incorporated by reference for all purposes as if fully set forth herein.

### BACKGROUND

1. Field

Exemplary embodiments of the present invention relate to a system and method for providing data to a plurality of user terminals that use a communication service, such as a messenger, a video call, an audio call, a social network service (SNS), and the like.

2. Discussion of the Background

With the emergence of evolved communication technologies, various is communication services, such as a messenger, a video call, an audio call, a social network service (SNS), and the like, may be provided through a mobile phone such as a smart phone in addition to a fixed terminal, such as a desktop computer, and the like.

The SNS refers to a service enabling a user to form a social network with other users via communication channels, e.g., the Internet, and to share interests and personal information with other users. Further, various communication services, including the SNS that enables users to share user information, such as interests, personal information, and the like, of the users as well as various information and data with each other, are drawing more attention of the users as time goes by.

However, conventional client-server based systems are generally limited to conventional configurations to receive control information from a client, and transmit, to the corresponding client requesting the control information, control result data corresponding to the control information.

Accordingly, there is an increasing desire for a communication service technology that may integrate and control user terminals of users who use a communication service, such as users registered in a messenger, users forming a social network, and users using a video or audio call.

The above information disclosed in this Background section is only for enhancement of understanding of the background of the invention and therefore it may contain information that does not form any part of the prior art nor what the prior art may suggest to a person of ordinary skill in the art.

### SUMMARY

Exemplary embodiments of the present invention provide a system and method for providing a communication service that provides an integrated virtual synchronization session so that a plurality of user terminals using a communication service may control a terminal of another user.

Exemplary embodiments of the present invention also provide a system and method for providing a communication service that provides, using a synchronization session, an advertisement, interested information, a search service, a ticket reserving service, and the like, to user terminals of users who use a communication service.

Additional features of the invention will be set forth in the description which follows, and in part will be apparent from the description, or may be learned by practice of the invention.

An exemplary embodiment of the present invention discloses a system to provide a communication service. The system includes a storage device, a synchronization session setting unit stored on the storage device and configured to set a synchronization session among a plurality of user terminals, and a control result data determining unit. The plurality of user terminals is in the communication service. The control result data determining unit is configured to determine first control result data corresponding to first terminal control information received from a first user terminal among the plurality of user terminals, and to transmit the first control result data to a second user terminal among the plurality of user terminals. A communication tool stored in each of the plurality of user terminals is activated for the communication service, and the synchronization session is set in the communication tool.

An exemplary embodiment of the present invention discloses a method that uses a processor to provide a communication service. The method includes setting a synchronization is session among a plurality of user terminals, receiving first terminal control information from a first user terminal among the plurality of user terminals, determining, by the processor, first control result data corresponding to the first terminal control information, and transmitting the first control result data to a second user terminal among the plurality of user terminals.

An exemplary embodiment of the present invention discloses a system to provide a communication service. The system includes a storage device, an information receiver configured to receive first terminal control information and session information from a first user terminal, the session information including information for setting a synchronization session among a plurality of user terminals including the first user terminal, and a synchronization session setting unit. The synchronization session setting unit is stored on the storage device and configured to set a synchronization session among the plurality of user terminals based on the session information, to process the first terminal control information, and to transmit the processed first terminal control information to a second user terminal among the plurality of user terminals.

An exemplary embodiment of the present invention discloses a method that uses a processor to provide a communication service. The method includes receiving first terminal control information and session information from a first user terminal, the session information including information for setting a synchronization session among a plurality of user terminals including the first user terminal, setting a synchronization session among the plurality of user terminals based on the session information, and processing the first terminal control information, and transmitting the first terminal control information to a second user terminal among the plurality of user terminals.

An exemplary embodiment of the present invention discloses a method that uses a processor to provide a communication service. The method includes setting a session of a communication service among a plurality of user terminals including a first user terminal and a second user terminal, receiving first terminal control information from the first user terminal via the session, determining, by the processor, first control result data according to the first terminal control information, and transmitting the first control result data to the second user terminal.

An exemplary embodiment of the present invention discloses a terminal to provide a communication service. The terminal includes a storage device, a synchronization session setting unit stored on the storage device and configured to set a synchronization session among the terminal and a plurality of user terminals, and a control result data determining unit. The control result data determining unit is configured to determine first control result data corresponding to first terminal control information input to the terminal, and to transmit the first control result data to a user terminal among the plurality of user terminals.

It is to be understood that both the foregoing general description and the following detailed description are exemplary and explanatory and are intended to provide further explanation of the invention as claimed

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the principles of the invention.

FIG. 1 is a block diagram illustrating a configuration of a system for providing a communication service according to an exemplary embodiment of the present invention.

FIG. 2 is a block diagram illustrating a configuration of a system for providing a communication service according to an exemplary embodiment of the present invention.

FIG. 3 is a block diagram illustrating the system for providing a communication service of FIG. 1 according to an exemplary embodiment of the present invention.

FIG. 4 is a diagram illustrating an example of displaying control result data transmitted through a synchronization session in the system for providing a communication service of FIG. 1 according to an exemplary embodiment of the present invention.

FIG. 5 is a diagram illustrating an example of displaying control result data transmitted through a synchronization session in the system for providing a communication service of FIG. 1 according to an exemplary embodiment of the present invention.

FIG. 6 is a diagram illustrating an example of displaying control result data transmitted through a synchronization session in the system for providing a communication service of FIG. 1 according to an exemplary embodiment of the present invention.

FIG. 7 is a block diagram illustrating the system for providing a communication service of FIG. 2 according to an exemplary embodiment of the present invention.

FIG. 8 is a block diagram illustrating an example of displaying control result data transmitted through a synchronization session in the system for providing a communication service of FIG. 2 according to an exemplary embodiment of the present invention.

FIG. 9 is a flowchart illustrating an operation of the system for providing a communication service of FIG. 1 according to an exemplary embodiment of the present invention.

FIG. 10 is a flowchart illustrating an operation of the system for providing a communication service of FIG. 2 according to an exemplary embodiment of the present invention.

### DETAILED DESCRIPTION OF THE ILLUSTRATED EMBODIMENTS

Exemplary embodiments will be described more fully hereinafter with reference to the accompanying drawings, in which exemplary embodiments of the invention are shown. This invention may, however, be embodied in many different forms and should not be construed as limited to the exemplary embodiments set forth herein. Rather, these embodiments are provided so that this disclosure is thorough, and will fully convey the scope of the invention to those skilled in the art. Throughout the drawings and the detailed description, unless otherwise described, the same drawing reference numerals are understood to refer to the same elements, features, and structures. The relative size and depiction of these elements may be exaggerated for clarity, illustration, and convenience.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, units, modules, integers, steps, operations, elements, components, etc., but do not preclude the presence or addition of one or more other features, regions, units, modules, integers, steps, operations, elements, components, etc., and/or groups thereof.

It will be understood that for the purposes of this disclosure, “at least one of” will be interpreted to mean any combination the enumerated elements following the respective language, including combination of multiples of the enumerated elements. For example, “at least one of X, Y, and Z” will be construed to mean X only, Y only, Z only, or any combination of two or more items X, Y, and Z (e.g. XYZ, XZ, YZ, X). It will be understood that when an element is referred to as being “connected to” another element, it can be directly connected to the other element, or intervening elements may be present. In contrast, when an element is referred to as being “directly connected to” another element, there are no intervening elements present.

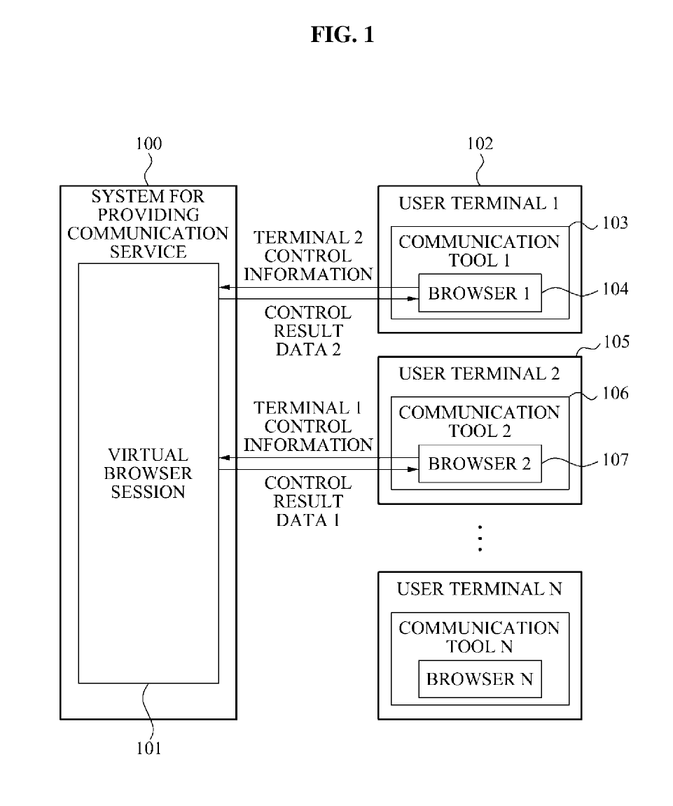

FIG. 1 is a block diagram illustrating a configuration of a system for providing a communication service according to an exemplary embodiment of the present invention.

Referring to FIG. 1, a system for providing a communication service 100 may set a synchronization session integrated among a plurality of user terminals that use a communication service. For example, the communication service may include a video call service, an audio call service, a social network service (SNS), a messenger service, and the like.

As an example, a communication tool may be stored in each of the plurality of user terminals that is in the communication service. The communication tool may correspond to an application for providing a communication service. For example, a ‘browser 1’ 104 embedded in a ‘communication tool 1’ 103 of a ‘user terminal 1’ 102 may receive, from a user 1, a selection of information about setting a synchronization session of a communication service. The ‘communication tool 1’ 103 may transmit, to the system for providing a communication service 100, the selected information about setting a synchronization session. A communication tool stored in each of the plurality of user terminals may be activated for the communication service, and the synchronization session may be set in the communication tool.

The system for providing a communication service 100 may set an integrated virtual browser session 101 for synchronizing the ‘user terminal 1’ 102 and a ‘user terminal 2’ 105 using a communication service. The system for providing a communication service 100 may perform, using the integrated virtual browser session 101, synchronization between the ‘browser 1’ 104 of the ‘user terminal 1’ 102 and a ‘browser 2’ 107 of the ‘user terminal 2’ 105. Through the synchronization, information including an advertisement, and the like, may be displayed on the ‘user terminal 1’ 102 and the ‘user terminal 2’ 105.

In response to receiving terminal control information from one of the plurality of user terminals using a communication service, the system for providing a communication service 100 may determine control result data corresponding to the terminal control information. Here, the terminal control information may include at least one of information about selecting an advertisement, information about reserving a ticket, information about a search service, and information about shopping. The system for providing a communication service 100 may transmit the control result data to the plurality of user terminals. In response to the receipt of the control result data, each of the plurality of user terminals may display the control result data.

As an example, if terminal control information displayed on the ‘user terminal 1’ 102 is selected by the user 1, the ‘user terminal 1’ 102 may transmit terminal 2 control information to the system for providing a communication service 100. For example, if an advertisement displayed on the ‘user terminal 1’ 102 is selected, the ‘user terminal 1’ 102 may transmit, to the system for providing a communication service 100, terminal 2 control information including information about selecting an advertisement.

The system for providing a communication service 100 may determine control result data 1 corresponding to the terminal 2 control information. Further, the system for providing a communication service 100 may transmit the determined control result data 1 to the ‘user terminal 1’ 102 and the ‘user terminal 2’ 105. For example, the system for providing a communication service 100 may determine an advertisement webpage corresponding to an advertisement selected by the ‘user terminal 1’ 102 in an advertisement database (not shown), and transmit the determined advertisement webpage to the ‘user terminal 1’ 102 and the ‘user terminal 2’ 105. Then, the ‘user terminal 1’ 102 and the ‘user terminal 2’ 105 may display the advertisement webpage. As described in the foregoing, even though the ‘user terminal 2’ 105 may not select an advertisement, synchronization set with the ‘user terminal 1’ 102 may allow the ‘user terminal 2’ 105 to display the control result data 1 corresponding to the terminal 2 control information selected by the ‘user terminal 1’ 102 while using a communication service. Thus, each of the ‘browser 1’ 104 and the ‘browser 2’ 107 may display the same control result data 1, thereby inducing the users to buy a product of an advertiser or a service, and promoting a common subject between the user 1 and a user 2. Similarly, if terminal control information displayed on the ‘user terminal 2’ 105 is selected by the user 2, the ‘user terminal 2’ 105 may transmit terminal 1 control information to the system for providing a communication service 100. For example, if an advertisement displayed on the ‘user terminal 2’ 105 is selected, the ‘user terminal 2’ 105 may transmit, to the system for providing a communication service 100, terminal 1 control information including information about selecting an advertisement. Further, if terminal control information displayed on the ‘user terminal 1’ 102 is selected by the user 1, the ‘user terminal 1’ 102 may transmit at least one of terminal 2 control information, terminal 3 control information, . . . , terminal N control information to the system for providing a communication service 100. Further, ‘user terminal 2’ 105 may allow the system for providing a communication service 100 to control the ‘user terminal 2’ 105 if the ‘user terminal 2’ 105 receives the control result data 1.

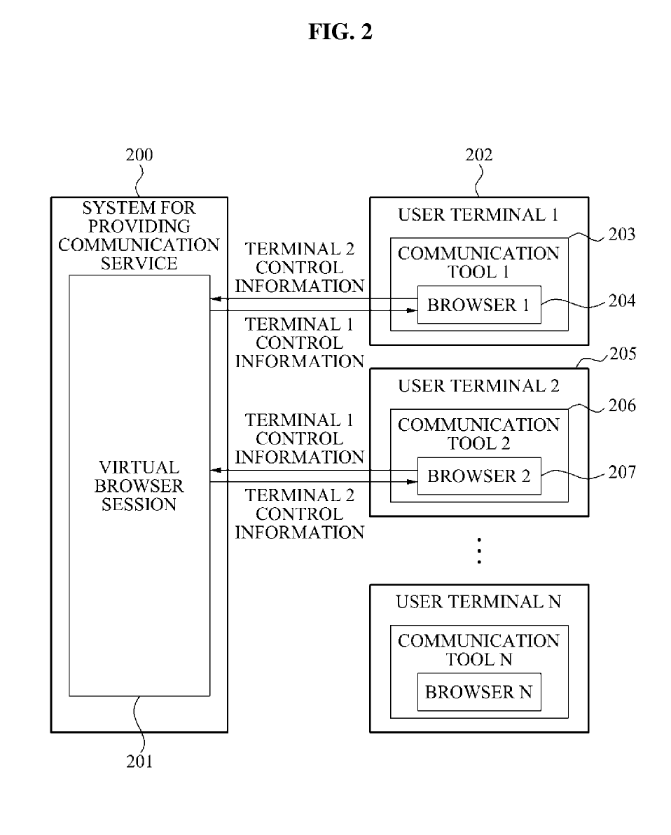

Examples in which the virtual browser session 101 of the system for providing a communication service 100 determines control result data corresponding to terminal control information, and the virtual browser session 101 that may directly provide user terminals with control result data in a browser screen form has been described with reference to FIG. 1. However, the virtual browser session 101 may process the terminal control information, and deliver the terminal control information to corresponding user terminals. Hereinafter, a configuration of delivering the terminal control information will be described with reference to FIG. 2.

FIG. 2 is a block diagram illustrating a configuration of a system for providing a communication service according to an exemplary embodiment of the present invention.

Referring to FIG. 2, a system for providing a communication service 200 may set a synchronization session integrated among a plurality of user terminals that use a communication service. For example, a ‘communication tool 1’ 203 embedded in a ‘user terminal 1’ 202 may generate a ‘browser 1’ 204 in the ‘user terminal 1’ 202, and the ‘user terminal 1’ 202 may transmit information about setting a synchronization session selected by a user 1 to the system for providing a communication service 200 through the ‘browser 1’ 204. A communication tool stored in each of the plurality of user terminals may be activated for the communication service, and the synchronization session may be set in the communication tool.

The system for providing a communication service 200 may set an integrated virtual browser session 201 for synchronizing the ‘user terminal 1’ 202 and a ‘user terminal 2’ 205 using a communication service. The system for providing a communication service 200 may set, using a single integrated virtual browser session 201, synchronization between the ‘browser 1’ 204 and a ‘browser 2’ 207.

Further, in response to receiving terminal control information from one of the plurality of user terminals that use a communication service, the system for providing a communication service 200 may process the received terminal control information, and transmit the terminal control information to other user terminals. The other user terminals may correspond to a terminal, among the plurality of user terminals participating in a session of the communication service, other than a terminal transmitting the terminal control information. The terminal control information may include at least one of information about selecting an advertisement, information about reserving a ticket, information about a search service, and information about shopping.

As an example, if terminal control information displayed on the ‘user terminal 1’ 202 is selected by the user 1, the ‘user terminal 1’ 202 may transmit terminal 2 control information to the system for providing a communication service 200. For example, if an advertisement displayed on the ‘user terminal 1’ 202 is selected, the ‘user terminal 1’ 202 may transmit, to the system for providing a communication service 200, terminal 2 control information including information about selecting an advertisement. Then, the system for providing a communication service 200 may process the information about selecting an advertisement, and transmit the information about selecting an advertisement to the ‘user terminal 2’ 205. For example, the system for providing a communication service 200 may process the information about selecting an advertisement so as to include “advertisement being is selected,” and transmit the information about selecting an advertisement to the ‘user terminal 2’ 205. Then, a ‘communication tool 2’ 206 may display the ‘browser 2’ 207 so that an advertisement may be selected through the ‘browser 2’ 207 based on the processed information about selecting an advertisement.

As described in the foregoing with reference to FIG. 2, the ‘user terminal 2’ 205 of FIG. 2 may not select terminal control information. For example, if the ‘user terminal 1’ 202 selects terminal control information, a browser screen for selecting terminal control information may be displayed on the ‘user terminal 2’ 205, and then control result data corresponding to the terminal control information may be displayed. On the other hand, the ‘user terminal 2’ 105 of FIG. 1 may not select terminal control information. For example, if the ‘user terminal 1’ 102 selects terminal control information, control result data corresponding to the terminal control information may be displayed on the ‘user terminal 2’ 105.

With respect to FIG. 1 and FIG. 2, it has been described that a ‘user terminal 1’ may transmit information about setting a synchronization session and terminal control information to a system for providing a communication service. Further, a ‘user terminal 2’ or a ‘user terminal N’ may transmit information about setting a synchronization session and terminal control information to a system for providing a communication service.

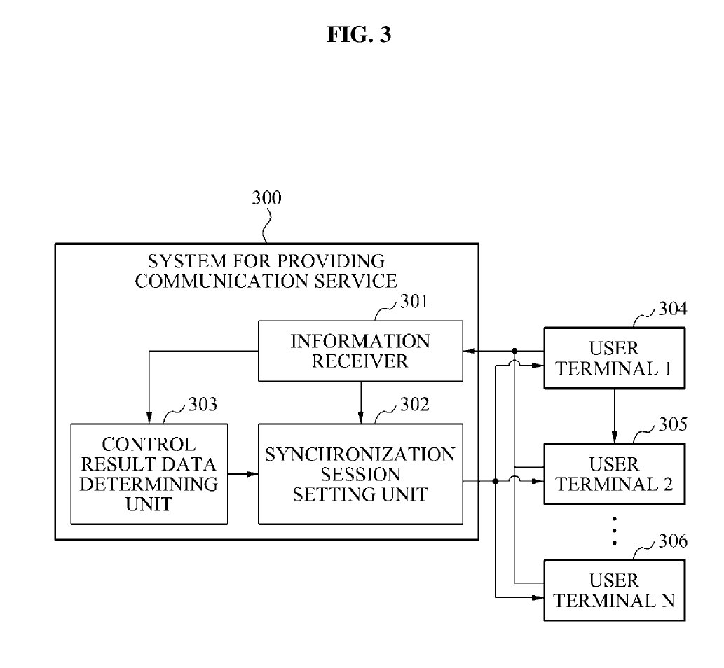

FIG. 3 is a block diagram illustrating the system for providing a communication service of FIG. 1 according to an exemplary embodiment of the present invention.

Referring to FIG. 3, a system for providing a communication service 300 may include an information receiver 301, a synchronization session setting unit 302, and a control result data determining unit 303.

The information receiver 301 may receive information about setting a synchronization session for setting a synchronization session integrated among a plurality of user terminals that use a communication service 304, 305, and 306. For example, the communication service may include a video call service, an audio call service, a SNS, a messenger service, and the like.

If the video call service is used as the communication service, the information receiver 301 may receive information about setting a synchronization session from one of user terminals of users that use the video call service.

The synchronization session setting unit 302 may set a synchronization session integrated among the plurality of user terminals using the communication service 304, 305, and 306 based on the information about setting a synchronization session. A communication tool stored in each of the plurality of user terminals may be activated for the communication service, and the synchronization session may be set in the communication tool. The synchronization session setting unit 302 may set, using a virtual browser session and a browser embedded in a communication tool of each of the plurality of user terminals 304, 305, and 306, an integrated synchronization session. As described in the foregoing, synchronization between the system for providing a communication service 300 and the plurality of user terminals 304, 305, and 306 may allow the plurality of user terminals using a communication service 304, 305, and 306 to display the same information such as an advertisement, and the like.

If terminal control information is received in response to information displayed on the plurality of user terminals 304, 305, and 306 being selected by one of a plurality of users, the control result data determining unit 303 may determine control result data corresponding to the terminal control information. The terminal control information may include at least one of information about selecting an advertisement, information about reserving a ticket, information about a search service, and information about shopping. The control result data determining unit 303 may transmit the determined control result data to a plurality of user terminals that use a communication service 304, 305, and 306. The control result data determining unit 303 may transmit, to the plurality of user terminals, control result data in form of a web browser.

As an example, in response to information about selecting an advertisement received from a ‘user terminal 1’ 304, the control result data determining unit 303 may determine an advertisement corresponding to the information about selecting an advertisement from an advertisement database (not shown). The control result data determining unit 303 may transmit, as the control result data, an advertisement webpage for the determined advertisement to the ‘user terminal 1’ 304 and a ‘user terminal 2’ 305. Then, the ‘user terminal 2’ 305 may display an advertisement webpage corresponding to an advertisement selected by a user 1 even though ‘the user terminal 2’ does not select the advertisement. The ‘user terminal 1’ 304 may display the advertisement webpage corresponding to the selected advertisement.

Further, in response to information about reserving a ticket received from the ‘user terminal 1’ 304, the control result data determining unit 303 may determine control result data including ticket information, such as time, seat, and the like, of a ticket desired to be reserved retrieved from a ticket reserving database (not shown) based on the information about reserving a ticket, for example. The control result data determining unit 303 may transmit, to the ‘user terminal 1’ 304 and the ‘user terminal 2’ 305, the determined control result data in a form of a web browser. Then, the ‘user terminal 1’ 304 and the ‘user terminal 2’ 305 may display control result data, such as a start time, a seat number, and the like, of the ticket desired to be reserved and selected by the user 1. Accordingly, the user 1 and a user 2 may participate to reserve a ticket for a performance or transportation, and the like.

Further, in response to information about a search service received from the ‘user terminal 1’ 304, the control result data determining unit 303 may transmit control result data including a search result corresponding to the information about a search service retrieved from a search database (not shown) to the ‘user terminal 1’ 304 and the ‘user terminal 2’ 305, for example. The control result data determining unit 303 may transmit a search result, as data, corresponding to a keyword input by the user 1 to the ‘user terminal 1’ 304 and the ‘user terminal 2’ 305 in a form of a web browser. Then, the ‘user terminal 1’ 304 and the ‘user terminal 2’ 305 may display the search result corresponding to the keyword input by the user 1.

Further, in response to information about shopping received from the ‘user terminal 1’ 304, the control result data determining unit 303 may determine information about a product corresponding to the information about shopping from a shopping information database (not shown), and transmit control result data including the determined information about a product to the ‘user terminal 1’ 304 and the ‘user terminal 2’ 305. Then, the ‘user terminal 1’ 304 and the ‘user terminal 2’ 305 may display the information about a product selected by the user 1. Accordingly, the user 1 and the user 2 may purchase a product after exchanging opinions on the product.

The control result data determining unit 303 may receive terminal control information for displayed control result data, process the received terminal control information, and transmit the terminal control information or the control result data to user terminals.

If terminal control information 2 is selected by the user 2 in a state in which control result data 1 corresponding to terminal control information 1 selected by the user 1 is displayed on the ‘user terminal 2’ 305, the control result data determining unit 303 may process control result data 2 corresponding to the terminal control information 2, and transmit the control result data 2 to the ‘user terminal 1’ 304. For example, the ‘user terminal 2’ 305 may display control result data corresponding to the start time of a performance selected by the user 1. In response to a seat number corresponding to the performance time being selected by the user 2, the ‘user terminal 2’ 305 may transmit, to the system for providing a communication service 300, information about reserving a ticket for the selected seat. Then, the control result data determining unit 303 may transmit, to the ‘user terminal 1’ 304 and the ‘user terminal 2’ 305, control result data corresponding to the information about reserving a ticket for the selected seat number.

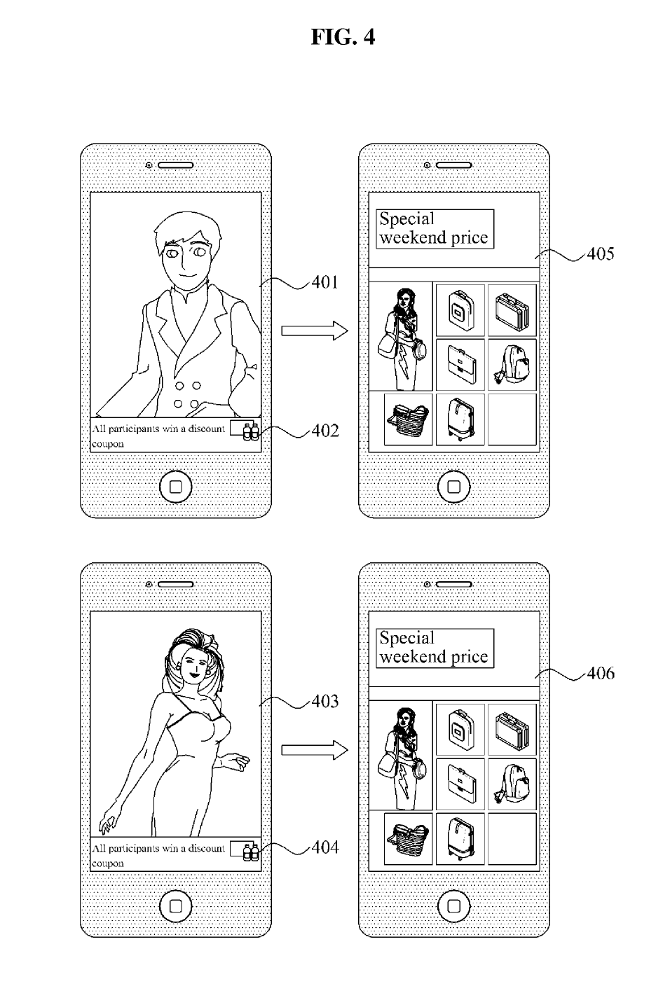

FIG. 4 is a diagram illustrating an example of displaying control result data transmitted through a synchronization session in the system for providing a communication service of FIG. 1 according to an exemplary embodiment of the present invention.

Referring to FIG. 4, a system for providing a communication service may transmit, to a user terminal 1 and a user terminal 2, control result data corresponding to terminal control information received from a user terminal 1 in a form of a web browser.

For example, if the user terminal 1 and the user terminal 2 use a video call service, and an advertisement 402 is selected by a user 1, the system for providing a communication service may transmit, to the user terminal 1 and the user terminal 2, an advertisement webpage corresponding to information about selecting an advertisement received from the user terminal 1. Then, a communication tool 1 of the user terminal 1 may display an advertisement webpage 405 on a screen of the user terminal 1 instead of displaying the user 2 using the video call service 401. Likewise, a communication tool 2 of the user terminal 2 may display an advertisement web page 406 on a screen of the user terminal 2 instead of displaying the user 1 using the video call service 403.

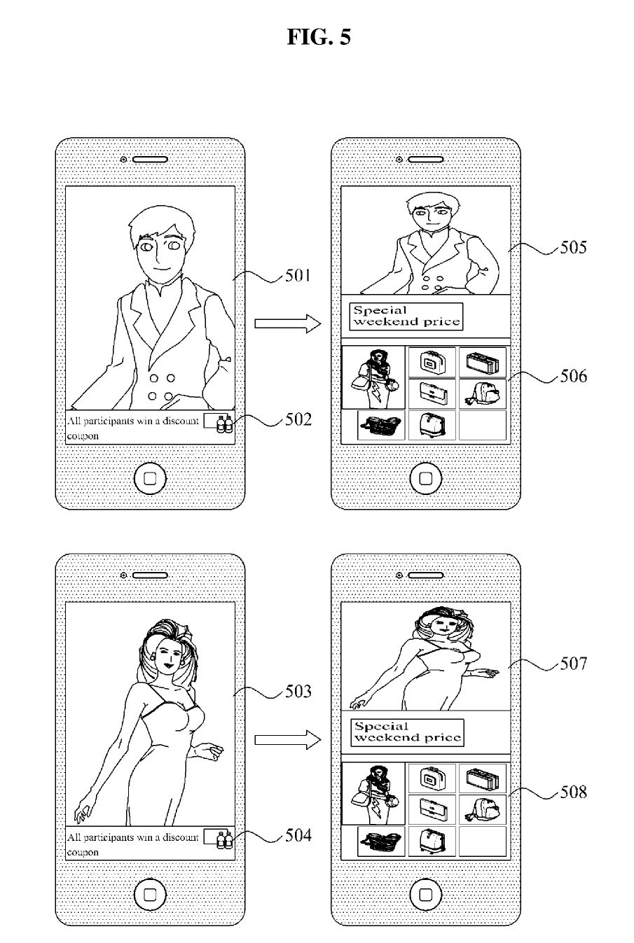

FIG. 5 is a diagram illustrating an example of displaying control result data transmitted through a synchronization session in the system for providing a communication service of FIG. 1 according to an exemplary embodiment of the present invention.

Referring to FIG. 5, if a user terminal 1 and a user terminal 2 use a video call service, and an advertisement 502 is selected by a user 1, a system for providing a communication service may transmit, to the user terminal 1 and the user terminal 2, an advertisement webpage corresponding to information about selecting an advertisement received from the user terminal 1. Then, a communication tool 1 of the user terminal 1 may divide a screen of the user terminal 1, and display each of an advertisement webpage 506 and a user 2 image 505 using the video call service on corresponding display areas of the screen of the user terminal 1 Likewise, a communication tool 2 of the user terminal 2 may divide a screen of the user terminal 2, and display each of an advertisement web page 508 and a user 1 image 507 using the video call service on corresponding display areas of the screen of the user terminal 2.

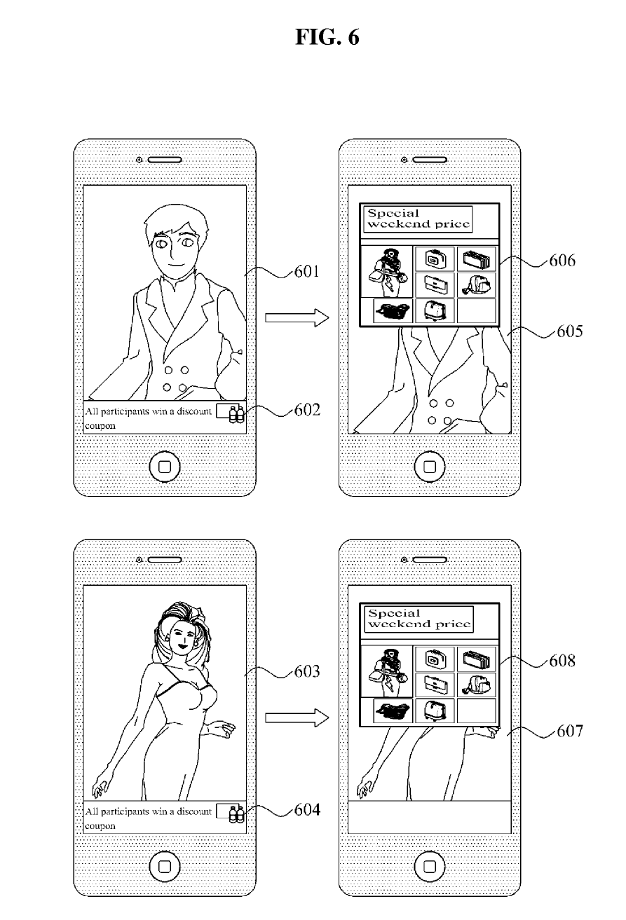

FIG. 6 is a diagram illustrating an example of displaying control result data transmitted through a synchronization session in the system for providing a communication service of FIG. 1 according to an exemplary embodiment of the present invention.

Referring to FIG. 6, if a user terminal 1 and a user terminal 2 use a video call service, and an advertisement 602 is selected by a user 1 using the user terminal 1, a system for providing a communication service may transmit, to the user terminal 1 and the user terminal 2, an advertisement webpage corresponding to information about selecting an advertisement received from the user terminal 1. Then, a communication tool 1 of the user terminal 1 may display a user 2 image 605 using the video call service on a screen of the user terminal 1, and an advertisement webpage 606 overlapping the user 2 image 605. Likewise, a communication tool 2 of the user terminal 2 may display a user 1 image 607 using the video call service on a screen of the user terminal 2, and an advertisement webpage 608 overlapping the user 1 image 607.

For convenience of description with respect to FIG. 4, FIG. 5, and FIG. 6, a configuration of displaying control result data on a user terminal has been described when a video call service is used for a communication service and advertisement information is used for terminal control information. However, user terminals may display control result data corresponding to information about reserving a ticket, a search service, and/or shopping selected from among various communication services, such as a messenger service, an SNS, and the like.

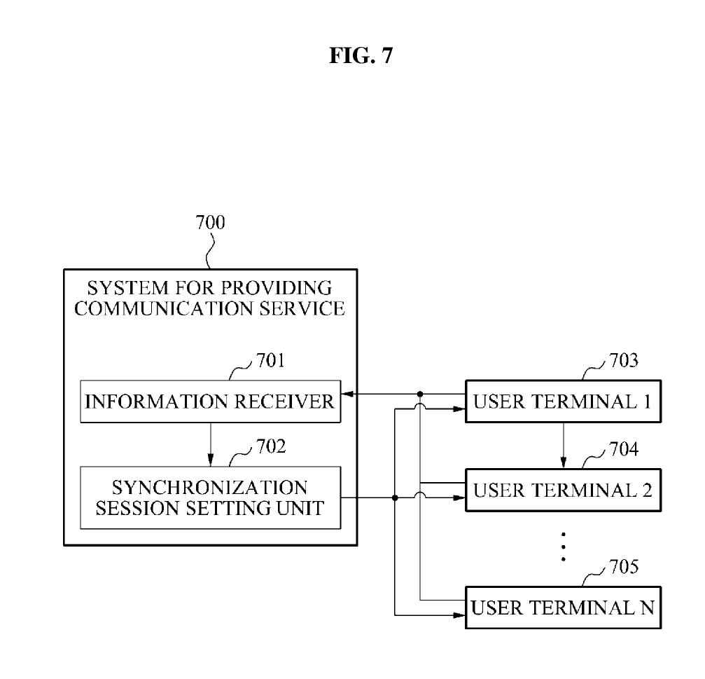

FIG. 7 is a block diagram illustrating the system for providing a communication service of FIG. 2 according to an exemplary embodiment of the present invention.

Referring to FIG. 7, a system for providing a communication service 700 may include an information receiver 701 and a synchronization session setting unit 702.

The information receiver 701 may receive, from one of a plurality of user terminals 703, 704, and 705, information about setting a synchronization session for setting a synchronization session integrated among a plurality of user terminals that use a communication service 703, 704, and 705. For example, the communication service may include a video call service, an audio call service, a SNS, a messenger service, and the like.

If a video call service is used as the communication service, the information receiver 701 may receive information about setting a synchronization session from one of user terminals of users that use the video call service.

Then, the synchronization session setting unit 702 may set a synchronization session integrated among the plurality of user terminals that use the communication service 703, 704, and 705 based on the information about setting a synchronization session. The synchronization session setting unit 702 may set an integrated synchronization session using a virtual browser session and a browser embedded in a communication tool of each of the plurality of user terminals 703, 704, and 705. Synchronization set among the system for providing a communication service 700 and the plurality of user terminals 703, 704, and 705 may allow the plurality of user terminals that use the communication service 703, 704, and 705 to display the same information, such as an advertisement, and the like.

Further, if terminal control information is received in response to information displayed on the plurality of user terminals 703, 704, and 705 being selected by one of a plurality of users, the synchronization session setting unit 702 may process and transmit the received terminal control information to at least one of the plurality of user terminals 703, 704, and 705. Then, a user terminal receiving the processed terminal control information may display a browser screen corresponding to the processed terminal control information. The terminal control information may include at least one of information about selecting an advertisement, information about reserving a ticket, information about a search service, and information about shopping.

For example, in response to information about selecting an advertisement received from a ‘user terminal 1’ 703, the synchronization session setting unit 702 may process the information about selecting an advertisement so as to include “advertisement selected,” and transmit the information about selecting an advertisement to a ‘user terminal 2’ 704. Then, the ‘user terminal 2’ 704 may display a browser screen on which an advertisement is selected based on the processed information about selecting an advertisement.

Further, in response to information about reserving a ticket received from the ‘user terminal 1’ 703, the synchronization session setting unit 702 may process the information about reserving a ticket so as to include “reserved ticket selected,” and transmit the information about reserving a ticket to the ‘user terminal 2’ 704, for example. Then, the ‘user terminal 2’ 704 may display a browser screen on which ticket information, such as a start time, a seat number, and the like, of a ticket desired to be reserved is selected based on the processed information about reserving a ticket. The reserved ticket may include a ticket of a performance, such as a play, a musical, a movie, and the like, and a ticket for transportation, such as a train, a plane, a bus, and the like.

Further, in response to information about a search service received from the ‘user terminal 1’ 703, the synchronization session setting unit 702 may process the information about a search service so as to include “keyword input,” and transmit the information about a search service to the ‘user terminal 2’ 704, for example. Then, the ‘user terminal 2’ 704 may display a browser screen on which a keyword is input based on the processed information about a search service.

Further, in response to information about shopping received from the ‘user terminal 1’ 703, the synchronization session setting unit 702 may process the information about shopping so as to include “purchased or interested product selected,” and transmit the information about shopping to the ‘user terminal 2’ 704, for example. Then, the ‘user terminal 2’ 704 may display a browser screen on which a purchased or interested product is selected based on the processed information about shopping.

As described in the foregoing, the system for providing a communication service 700 may provide, using an integrated synchronization session in a virtual browser session form, synchronization among user terminals that use a communication service 703, 704, and 705. Terminal control information selected from terminal control information commonly displayed on user terminals through synchronization may be processed and provided to other user terminals, thereby drawing attention of users to displayed terminal control information, such as an advertisement, and the like, and enhancing advertisement effects in the advertisement.

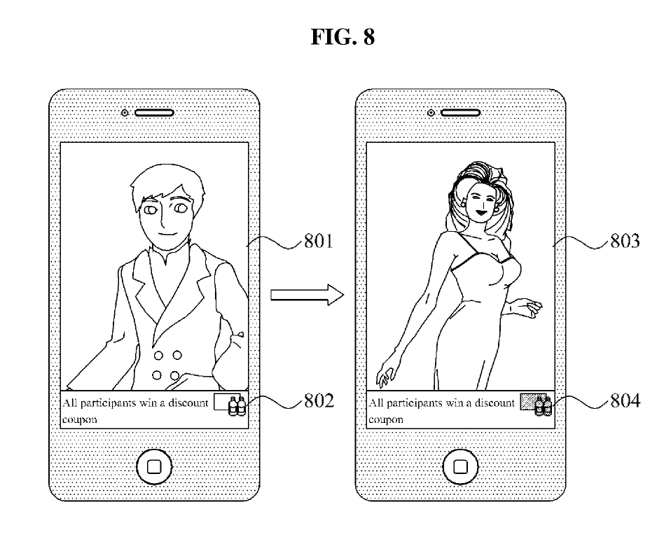

FIG. 8 is a block diagram illustrating an example of displaying control result data transmitted through a synchronization session in the system for providing a communication service of FIG. 2 according to an exemplary embodiment of the present invention.

Referring to FIG. 8, if a user terminal 1 and a user terminal 2 use a video call service, and an advertisement 802 is selected by a user 1, a system for providing a communication service may process information about selecting an advertisement received from the user terminal 1, and transmit the information about selecting an advertisement to the user terminal 2. Then, the user terminal 2 may display a browser screen 804 on which an advertisement is selected based on the processed information about selecting an advertisement. Subsequently, the user terminal 2 may display an advertisement webpage corresponding to the selected advertisement.

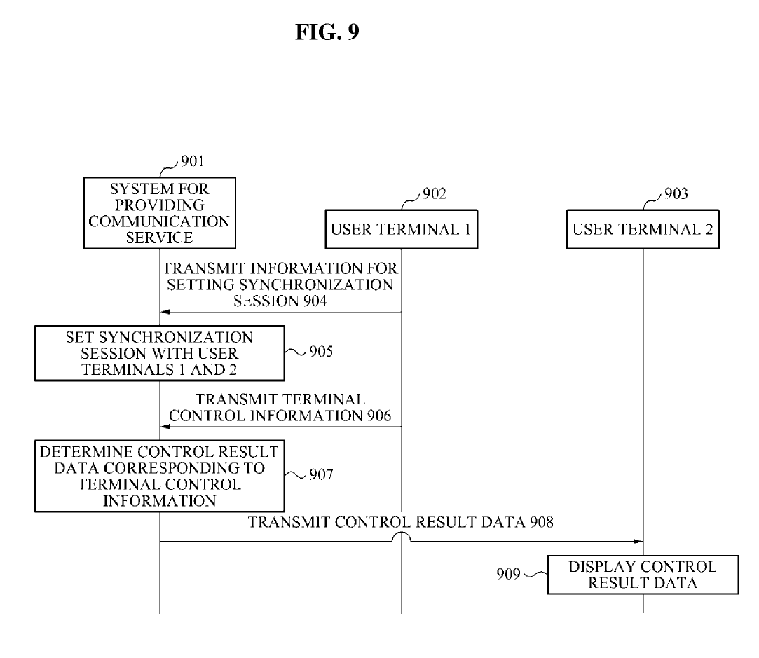

FIG. 9 is a flowchart illustrating an operation of the system for providing a communication service of FIG. 1 according to an exemplary embodiment of the present invention.

Referring to FIG. 9, in response to receiving information about setting a synchronization session from a ‘user terminal 1’ 902 in operation 904, a system for providing a communication service 901 may set an integrated synchronization session between the ‘user terminal 1’ 902 and a ‘user terminal 2’ 903 that use a communication service in operation 905. The system for providing a communication service 901 may set a synchronization session using a browser embedded in each of the ‘user terminal 1’ 902 and the ‘user terminal 2’ 903.

Further, the system for providing a communication service 901 may synchronize, using a virtual browser session, a browser 1 embedded in a communication tool 1 of the ‘user terminal 1’ 902 and a browser 2 embedded in a communication tool 2 of the ‘user terminal 2’ 903.

In operation 906, in response to synchronization session being set, the system for providing a communication service 901 may receive terminal control information from the ‘user terminal 1’ 902. For example, after setting a synchronization session, the ‘user terminal 1’ 902 and the ‘user terminal 2’ 903 that use a communication service may display the same information or a portion of the information displayed on the ‘user terminal 1’ 902, such as an advertisement, a performance, and the like. In response to displayed information being selected by a user 1, the ‘user terminal 1’ 902 may transmit terminal control information including selected information to the system for providing a communication service 901. The terminal control information may include at least one of information about selecting an advertisement, information about reserving a ticket, information about a search service, and information about shopping.

In operation 907, the system for providing a communication service 901 may determine control result data corresponding to the terminal control information.

In operation 908, the system for providing a communication service 901 may transmit, to the ‘user terminal 1’ 902 and the ‘user terminal 2’ 903, the control result data in a form of a web browser. In operation 909, the ‘user terminal 1’ 902 and the ‘user terminal 2’ 903 may display the control result data.

For example, in response to a receipt of information about selecting an advertisement, the system for providing a communication service 901 may determine an advertisement webpage corresponding to an advertisement selected by the user 1. The system for providing a communication service 901 may transmit the advertisement webpage to the ‘user terminal 1’ 902 and the ‘user terminal 2’ 903. Then, the ‘user terminal 1’ 902 and the ‘user terminal 2’ 903 may display the advertisement webpage.

Further, in response to user 2′s selection of information on the advertisement webpage, the ‘user terminal 2’ 903 may transmit, to the system for providing a communication service 901, terminal control information for the selected information. The system for providing a communication service 901 may process the terminal control information received from the ‘user terminal 2’ 903, and transmit the terminal control information to the ‘user terminal 1’ 902. Then, the ‘user terminal 1’ 902 may generate and display a browser screen so that information selected by the user 2 may be selected on the displayed advertisement webpage based on the processed terminal control information.

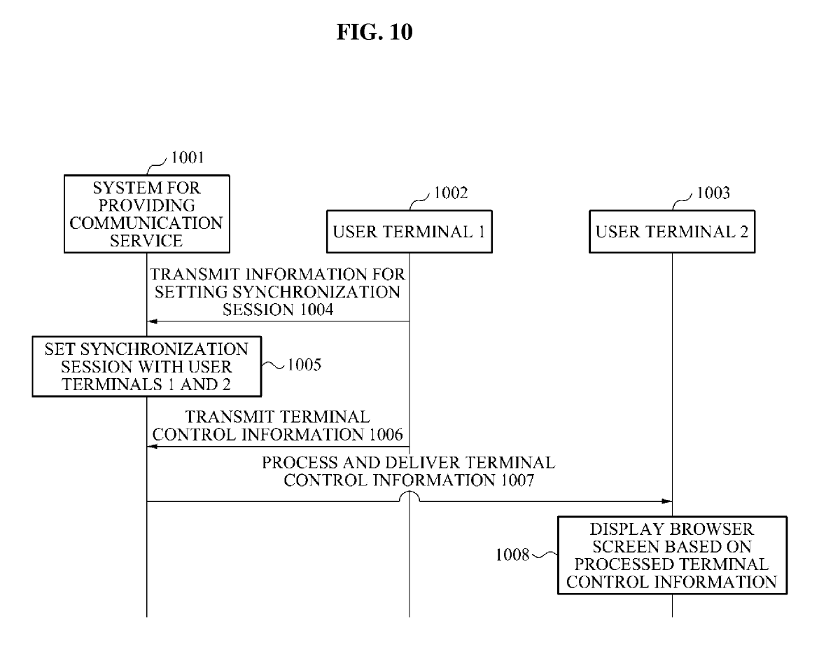

FIG. 10 is a flowchart illustrating an operation of the system for providing a communication service of FIG. 2 according to an exemplary embodiment of the present invention.

A configuration of setting a synchronization session, and receiving terminal control information from a ‘user terminal 1’ 1002 in response to setting of a synchronization session, described in operations 1004 through 1006 of FIG. 10, may be similar to a configuration described in operations 904 through 906 of FIG. 9 and thus, repeated descriptions will be omitted for conciseness.

In operation 1007, a system for providing a communication service 1001 may process terminal control information received from a ‘user terminal 1’ 1002, and transmit the terminal control information to a ‘user terminal 2’ 1003. The terminal control information may include at least one of information about selecting an advertisement, information about reserving a ticket, information about a search service, and information about shopping.

For example, if the terminal control information received from the ‘user terminal 1’ 1002 corresponds to information about selecting an advertisement, the system for providing a communication service 1001 may process the information about selecting an advertisement to include “advertisement selected,” and deliver the information about selecting an advertisement to the ‘user terminal 2’ 1003.

Further, if the terminal control information received from the ‘user terminal 1’ 1002 corresponds to information about reserving a ticket, the system for providing a communication service 1001 may process the information about reserving a ticket so as to include “reserved ticket selected,” and transmit the information about reserving a ticket to the ‘user terminal 2’ 1003, for example.

Further, if the terminal control information received from the ‘user terminal 1’ 1002 corresponds to information about a search service, the system for providing a communication service 1001 may process the information about a search service so as to include “keyword input,” and transmit the information about a search service to the ‘user terminal 2’ 1003, for example.

Further, if the terminal control information received from the ‘user terminal 1’ 1002 corresponds to information about shopping, the system for providing a communication service 1001 may process the information about shopping so as to include “purchased or interested product selected,” and deliver the information about shopping to the ‘user terminal 2’ 1003, for example.

Subsequently, in operation 1008, the ‘user terminal 2’ 1003 may generate a browser screen so that information selected by a user 1 may be selected based on the processed terminal control information. The ‘user terminal 2’ 1003 may display the generated browser screen. For example, if an advertisement is selected by the user 1, the ‘user terminal 2’ 1003 may generate and display a browser screen so that an advertisement, among pieces of information displayed on the ‘user terminal 2’ 1003, selected by the user 1 may be selected.

The exemplary embodiments according to the present invention may be recorded in computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the well-known variety and available to those having skill in the computer software arts. Examples of computer-readable media include magnetic media such as hard disks, floppy disks, and magnetic tape; optical media such as CD ROM discs and DVD; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

According to exemplary embodiments of the present invention, it is possible to provide an integrated virtual synchronization session so that a plurality of user terminals using a communication service may control a terminal of another user.

According to exemplary embodiments of the present invention, there is provided a system and method for providing a communication service that provides, using a synchronization session, an advertisement, interested information, a search service, a ticket reserving service, and the like to user terminals included in users that use a communication service, thereby inducing the users to buy a product of an advertiser or a service, and promoting a common subject between users during a communication, such as a video call, a phone conversation.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A system to provide a communication service, comprising:
a storage device;
a synchronization session setting unit stored on the storage device and configured to set a synchronization session among a plurality of user terminals, the plurality of user terminals being in the communication service; and
a control result data determining unit configured to determine first control result data corresponding to first terminal control information received from a first user terminal among the plurality of user terminals, and to transmit the first control result data to a second user terminal among the plurality of user terminals,
wherein a communication tool stored in each of the plurality of user terminals is activated for the communication service, and the synchronization session is set in the communication tool.

2. The system of claim 1, wherein the synchronization session setting unit is configured to set the synchronization session using browsers embedded in the plurality of user terminals.

3. The system of claim 1, wherein:
the control result data determining unit is configured to transmit the first control result data to the first user terminal, and
the first control result data is configured to be displayed on at least one of the first user terminal and the second user terminal.

4. The system of claim 3, wherein the control result data determining unit is configured to receive second terminal control information from the second user terminal, to determine second control result data based on the second terminal control information, and to transmit the second control result data to the first user terminal, and
wherein the second terminal control information is associated with the first control result data.

5. The system of claim 4, wherein the second control result data is configured to be displayed on the first user terminal.

6. A method that uses a processor to provide a communication service, comprising:
setting a synchronization session among a plurality of user terminals, the plurality of user terminals being in the communication service;
receiving first terminal control information from a first user terminal among the plurality of user terminals;
determining, by the processor, first control result data corresponding to the first terminal control information; and
transmitting the first control result data to a second user terminal among the plurality of user terminals,
wherein a communication tool stored in each of the plurality of user terminals is activated for the communication service, and the synchronization session is set in the communication tool.

7. The method of claim 6, wherein the synchronization session is set using browsers embedded in the plurality of user terminals.

8. The method of claim 6, wherein:
the transmitting comprises transmitting the first control result data to the first user terminal, and
the first control result data is configured to be displayed on at least one of the first user terminal and the second user terminal.

9. The method of claim 8, wherein the transmitting comprises:
receiving second terminal control information from the second terminal, the second terminal control information being associated with the first control result data;
determining second control result data based on the second terminal control information; and
transmitting the second control result data to the first user terminal.

10. The method of claim 9, wherein the second control result data is configured to be displayed on the first user terminal.

11. A non-transitory computer-readable recording medium comprising an executable program for instructing a computer, when executed by the computer, to perform the method of claim 6.

12. A system to provide a communication service, comprising:
a storage device;
an information receiver configured to receive first terminal control information and session information from a first user terminal, the session information comprising information for setting a synchronization session among a plurality of user terminals comprising the first user terminal, the plurality of user terminals being in the communication service; and
a synchronization session setting unit stored on the storage device and configured to set a synchronization session among the plurality of user terminals based on the session information, to process the first terminal control information, and to transmit the processed first terminal control information to a second user terminal among the plurality of user terminals,
wherein a communication tool stored in each of the plurality of user terminals is activated for the communication service, and the synchronization session is set in the communication tool.

13. The system of claim 12, wherein the synchronization session setting unit is configured to set the synchronization session using browsers embedded in the plurality of user terminals.

14. The system of claim 12, wherein
the processed first terminal control information is transmitted to be displayed as a browser screen in the second user terminal.

15. A method that uses a processor to provide a communication service, comprising:
receiving first terminal control information and session information from a first user terminal, the session information comprising information for setting a synchronization session among a plurality of user terminals comprising the first user terminal;
setting a synchronization session among the plurality of user terminals based on the session information, the plurality of user terminals being in the communication service; and
processing, by the processor, the first terminal control information, and transmitting the first terminal control information to a second user terminal among the plurality of user terminals,
wherein a communication tool stored in each of the plurality of user terminals is activated for the communication service, and the synchronization session is set in the communication tool.

16. The method of claim 15, wherein the synchronization session is set using browsers embedded in the plurality of user terminals.

17. The method of claim 15, wherein the processed first terminal control information is transmitted to be displayed as a browser screen in the second user terminal.

18. A non-transitory computer-readable recording medium comprising an executable program for instructing a computer, when executed by the computer, to perform the method of claim 15.

19. The system of claim 1, wherein the first terminal control information comprises at least one of information about selecting an advertisement, information about reserving a ticket, information about a search service, and information about shopping.

20. The method of claim 6, wherein the first terminal control information comprises at least one of information about selecting an advertisement, information about reserving a ticket, information about a search service, and information about shopping.
